(19) United States
(12) Patent Application Publication
(10) Pub. No.: US 2019/0165336 A1
(43) Pub. Date: May 30, 2019

(54) BATTERY CASE, BATTERY, LIQUID CRYSTAL POLYMER, AND ARTICLE

(71) Applicant: SAMSUNG ELECTRONICS CO., LTD., Suwon-si (KR)

(72) Inventors: In Ki KIM, Hwaseong-si (KR); Kyeong PANG, Suwon-si (KR); In KIM, Suwon-si (KR); Feifei FANG, Suwon-si (KR); Joungeun YOO, Seongnam-si (KR); Ginam KIM, Seongnam-si (KR); In Su LEE, Hwaseong-si (KR)

(21) Appl. No.: 16/204,304

(22) Filed: Nov. 29, 2018

(30) Foreign Application Priority Data
Nov. 30, 2017 (KR) 10-2017-0163679

(51) Int. Cl. H01M 2/02; H01M 2/04; H01M 6/46; H01M 10/0525; C08G 63/60; C08G 69/44; C09K 19/38

(52) U.S. Cl. CPC H01M 2/0262; H01M 2/0478; H01M 2/0202; C09K 19/3809; H01M 10/0525; C08G 63/605; C08G 69/44; H01M 6/46

(57) ABSTRACT

A battery case comprising a container configured to house an electrode assembly, wherein the container comprises a bottom wall and a plurality of side walls, the bottom wall and the plurality of side walls are integrated to define an internal space for housing the electrode assembly and to further define a top opening on an opposing side from the bottom wall, at least one of the bottom wall and the plurality of side walls comprises a liquid crystal polymer, the liquid crystal polymer comprises a plurality of blocks comprising an average of about 2 to about 5 structural units derived from hydroxybenzoic acid, and the container has a water vapor transmission rate at a wall thickness of 1 mm of less than about 0.07 g/m²/day, as measured at 38° C. and a relative humidity of 100% according to ISO 15106 and ASTM F1249.

### CROSS-REFERENCE TO RELATED APPLICATION

This application claims priority to and the benefit of Korean Patent Application No. 10-2017-0163679 filed in the Korean Intellectual Property Office on Nov. 30, 2017, and all the benefits accruing therefrom under 35 U.S.C. § 119, the entire content of which is incorporated herein by reference.

### BACKGROUND

### 1. Field

This disclosure relates to a battery case, a battery, a liquid crystal polymer for forming the battery case, and an article including the liquid crystal polymer.

### 2. Description of the Related Art

As various mobile electronic devices and means of electric transportation are developed, there is continuing interest in developing power source (e.g., a battery) for supplying them with electricity (or motive power).

The battery may be housed in a battery case, and the unit then disposed individually or as a module including one or more units in these devices or means of transportation. Accordingly, further development of technology capable of improving properties of the battery case is needed.

### SUMMARY

An embodiment provides a battery case having improved moisture transmission resistivity and workability.

Another embodiment provides a battery including the battery case.

Yet another embodiment provides a liquid crystal polymer having improved workability and moisture transmission resistivity.

Still another embodiment provides an article including the liquid crystal polymer having improved workability and moisture transmission resistivity.

In an embodiment, a battery case includes a container configured to house an electrode assembly, wherein the container includes a bottom wall and a plurality of side walls, the bottom wall and the plurality of side walls are integrated to define an internal space therein for housing the electrode assembly and to further define a top opening on an opposing side from the bottom wall, at least one of the bottom wall and the plurality of side walls includes a liquid crystal polymer, the liquid crystal polymer includes a plurality of blocks including an average of about 2 to about 5 structural units derived from hydroxybenzoic acid (HBA), and the container has a water vapor transmission rate (WVTR) at a wall thickness of 1 millimeter (mm) of less than about 0.07 grams per square meter per day (g/m²/day), as measured at 38° C. and a relative humidity of 100% according to ISO 15106 and ASTM F1249.

A total amount of the structural units derived from the hydroxybenzoic acid and forming the plurality of blocks in the liquid crystal polymer may be greater than or equal to about 30 mole percent (mol %), based on a total mole number of structural units of the liquid crystal polymer.

A total amount of the structural units derived from the hydroxybenzoic acid and forming the plurality of blocks in the liquid crystal polymer may be less than about 70 mol %, based on a total mole number of structural units of the liquid crystal polymer.

The plurality of blocks may have an average of about 2 to about 4 structural units derived from hydroxybenzoic acid.

The total amount of the structural units derived from hydroxybenzoic acid and forming the plurality of blocks in the liquid crystal polymer may be greater than or equal to about 35 mol % and less than or equal to about 65 mol %, based on a total mole number of the total structural units of the liquid crystal polymer.

The liquid crystal polymer may further include at least one structural unit selected from a structural unit derived from an aromatic dicarboxylic acid, a structural unit derived from an aromatic diol, and a structural unit derived from an aromatic hydroxy carboxylic acid.

The structural unit derived from the aromatic dicarboxylic acid may be a structural unit derived from at least one of terephthalic acid, 4,4′-biphenyldicarboxylic acid, 4,4′-terphenyldicarboxylic acid, 1,6-naphthalenedicarboxylic acid, 2,6-naphthalenedicarboxylic acid, 1,4-naphthalenedicarboxylic acid, 2,7-naphthalenedicarboxylic acid, diphenylether-4,4′-dicarboxylic acid, diphenoxyethane-4,4′-dicarboxylic acid, diphenoxybutane-4,4′-dicarboxylic acid, diphenylethane-4,4′-dicarboxylic acid, isophthalic acid, diphenylether-3,3′-dicarboxylic acid, diphenoxyethane-3,3′-dicarboxylic acid, diphenylethane-3,3′-dicarboxylic acid, chloroterephthalic acid, dichloroterephthalic acid, dichloroisophthalic acid, bromoterephthalic acid, methylterephthalic acid, dimethylterephthalic acid, ethylterephthalic acid, methoxyterephthalic acid, and ethoxyterephthalic acid.

The structural unit derived from the aromatic diol may be a structural unit derived from at least one of catechol, resorcinol, hydroquinone, 4,4′-dihydroxybiphenyl, 2,2-bis(4′-β-hydroxyethoxyphenyl)propane, bis(4-hydroxyphenyl) sulfone, bis(4-β-hydroxyethoxyphenyl)sulfonic acid, 9,9′-bis(4-hydroxyphenyl)fluorene, 3,3′-dihydroxybiphenyl, 4,4′-dihydroxyterphenyl, 2,6-naphthalenediol, 4,4′-dihydroxydiphenylether, bis(4-hydroxyphenoxy)ethane, 3,3′-dihydroxydiphenylether, 1,6-naphthalenediol, 2,2-bis(4-hydroxyphenyl)propane, bis(4-hydroxyphenyl)methane, chlorohydroquinone, methylhydroquinone, tert-butylhydroquinone, phenylhydroquinone, methoxyhydroquinone, phenoxyhydroquinone, 4-chlororesorcinol, and 4-methylresorcinol.

The structural unit derived from the aromatic hydroxy carboxylic acid may be a structural unit derived from at least one of glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2, 5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, and p-β-hydroxyethoxybenzoic acid.

The liquid crystal polymer may further include about 30 mol % or less of the structural unit derived from an aromatic dicarboxylic acid and about 30 mol % or less of the structural unit derived from an aromatic diol, based on a total mole number of structural units of the liquid crystal polymer.

The structural unit derived from an aromatic dicarboxylic acid may include a structural unit derived from at least one of terephthalic acid and isophthalic acid, and the structural unit derived from an aromatic diol may include a structural unit derived from at least one of hydroquinone and 4,4′-dihydroxybiphenyl.

The liquid crystal polymer may further include about 30 mol % or less of a structural unit derived from an ester that is derived from an aromatic dicarboxylic acid and an aliphatic diol, based on the total mole number of structural units of the liquid crystal polymer.

The structural unit derived from the ester monomer includes at least one of ethylene terephthalate, ethylene naphthalate, trimethylene terephthalate, and butylene terephthalate.

A melting point of the liquid crystal polymer may be less than or equal to about 320° C.

The battery case may further include a lid configured to cover at least a part of the top opening of the container, and having at least one of a positive terminal and a negative terminal.

The lid may include the liquid crystal polymer.

In another embodiment, the battery includes the battery case according to an embodiment, and an electrode assembly including a positive electrode and a negative electrode housed in the internal space of the container of the battery case.

The electrode assembly may not include a metal exterior material.

The electrode assembly may be an electrode assembly configured for use as a rechargeable lithium battery.

In another embodiment, a liquid crystal polymer includes a plurality of blocks including an average of about 2 to about 5 structural units derived from hydroxybenzoic acid, wherein a total amount of the structural units derived from the hydroxybenzoic acid of the plurality of blocks in the liquid crystal polymer is greater than or equal to about 30 mol % and less than about 70 mol %, based on a total mole number of the structural units of the liquid crystal polymer.

In another embodiment, a method for manufacturing the liquid crystal polymer includes providing an oligomer comprising an average of about 2 to about 5 structural units derived from hydroxybenzoic acid; and polymerizing the oligomer and one or more monomers to obtain the liquid crystal polymer.

In another embodiment, an article includes the liquid crystal polymer according to an embodiment.

The battery case according to an embodiment includes a block-type liquid crystal polymer having a plurality of blocks including an average of about 2 to about 5 structural units derived from hydroxybenzoic acid, and thus shows improved barrier characteristics, as well as excellent workability, due to a lowered melting point of the liquid crystal polymer. Accordingly, the battery case according to an embodiment may be advantageously used as a battery case for a rechargeable lithium battery requiring a low water vapor transmission rate and can be manufactured to have a desired shape and size in a method such as injection molding. In addition, the battery case has a light weight and is strong against an impact and thus may be advantageously applied to a battery module for an electric vehicle, which includes a plurality of battery cells, and thus supply a large capacity of electricity.

### BRIEF DESCRIPTION OF THE DRAWINGS

The above and other advantages and features of this disclosure will become more apparent by describing in further detail exemplary embodiments thereof with reference to the accompanying drawings.

FIG. 1 is an exploded perspective view of a battery case according to an embodiment.

FIG. 2 is an exploded perspective view of a battery case according to another embodiment.

FIG. 3 is a graph of intensity (arbitrary units, a.u.) versus chemical shift (δ, part per million (ppm)) and shows a proton nuclear magnetic resonance (¹H-NMR) spectrum of the liquid crystal polymer according to Example 2 prepared from the oligomer of hydroxybenzoic acid having a number average degree of polymerization of 2.64, as prepared in Synthesis Example 2.

FIG. 4 is a graph of intensity (a.u.) versus chemical shift (δ, ppm) and shows a ¹H-NMR spectrum of the liquid crystal polymer according to Example 3 prepared from the oligomer of hydroxybenzoic acid having a number average degree of polymerization of 4, as prepared in Synthesis Example 3.

FIG. 5 is a graph of intensity (a.u.) versus chemical shift (δ, ppm) and shows a ¹H-NMR spectrum of the liquid crystal polymer having a random-type copolymer according to Comparative Example 2 that is prepared by polymerization of hydroxybenzoic acid as a monomer.

### DETAILED DESCRIPTION

Advantages and characteristics of this disclosure, and a method for achieving the same, will become evident referring to the following example embodiments together with the drawings attached hereto. Hereinafter, embodiments of the present disclosure are described in detail. However, these embodiments are exemplary, the present disclosure is not limited thereto, and the embodiments should not be construed as being limited to the embodiments set forth herein.

If not defined otherwise, all terms (including technical and scientific terms) in the specification may be defined as commonly understood by one having ordinary skilled in the art. The terms defined in a generally-used dictionary may not be interpreted ideally or exaggeratedly unless clearly defined. In addition, unless explicitly described to the contrary, the word “comprise” and variations such as “comprises” or “comprising”, will be understood to imply the inclusion of stated elements but not the exclusion of any other elements.

Further, the singular includes the plural unless mentioned otherwise.

In the drawings, the thickness of each element is exaggerated for clarity. Like reference numerals designate like elements throughout the specification. It will be understood that when an element such as a layer, film, region, or plate is referred to as being “on” another element, it can be directly on the other element or intervening elements may also be present. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10%, or 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Recently, research on an electric vehicle (EV) using at least one battery system to supply a part or entire part of a motive power is actively being performed. The electric vehicle discharges fewer pollutants compared with a traditional vehicle operated by an internal combustion engine, and shows much higher fuel efficiency. Some electric vehicles using electricity use no gasoline at all, or obtain their entire motive power from electricity. As research on the electric vehicles is increased, there is a continuing need for an improved power source, such as, for example, an improved battery module.

A rechargeable lithium battery capable of being charged and discharged and having high energy density is considered as an electrochemical device of the battery module for these electric vehicles. However, as for the rechargeable lithium battery, when moisture is permeated through a battery exterior case, hydrofluoric acid (HF) is generated inside the case and causes performance degradation of an electrode. Accordingly, in order to prevent this performance degradation, an aluminum material having improved moisture transmission resistance is mainly used as a case for a rechargeable lithium battery. In other words, an electrode assembly including positive and negative electrodes is inserted into a case such as an aluminum pouch and then together into an aluminum can, sealed to make a battery cell, and a plurality of the battery cells are then used to form a battery module. However, since this method requires a complicated assembly process, a high manufacture time, and a high cost, its productivity can be improved. Accordingly, a cell-module with an integrated structure is desirable without the need for forming a separate battery cell after forming the electrode assembly To realize this cell-module having an integrated structure, further improvements to mechanical strength, moisture transmission resistance, and the like, are desirable.

On the other hand, since a battery case formed of a conventional metal has a limited shape due to a limit in terms of a metal manufacture technology, a battery case having a desired shape and/or size requires a multistep process, a higher cost, and a high manufacture time. In addition, larger metal cases are heavy due to the weight of the metal and, when a plurality of containers are included in order to house a plurality of battery cells, become heavier and even more expensive. Accordingly, there is a continuing need for a material capable of solving the problems of heat management, moisture transmission, and the like, and that is appropriate for manufacturing an efficient battery case and a battery including the same with a lower cost.

The liquid crystal polymers are typically an aromatic polyester prepared from an aromatic monomer and is an engineering thermoplastic having high heat resistance. The liquid crystal polymer has a high melting point of about 300° C. or greater, and thus a melting process thereof is difficult. Accordingly, there have been many attempts to improve workability by lowering the melting point of the liquid crystal polymer. Alternatively, there have been attempts to increase mechanical properties of a polymer by copolymerizing a liquid crystal polymer with another polymer that is not a liquid crystal polymer, such as, for example, PET (polyethylene terephthalate), PPT (polypropylene terephthalate), PTMT (polytrimethylene terephthalate), PEN (polyethylene naphthalate), and the like.

In terms of the structure, a conventional liquid crystal polymer is a type of random copolymer, which is obtained by one copolymerization reaction of aromatic monomers. An article produced by injection molding of a liquid crystal polymer having a random-type copolymer has inferior barrier characteristics, for example, a water vapor transmission rate (WVTR) at a wall thickness of 1 mm of greater than or equal to about 0.07 g/m²/day, as measured at 38° C. and a relative humidity of 100% according to ISO 15106 and ASTM F1249. The composition of the monomers or a structure of the polymer have not been explored to improve barrier characteristics of a liquid crystal polymer.

The present inventors have developed a battery case capable of being moldable into a desirable size and a shape, which uses a light-weight and inexpensive polymer resin, and a battery including the same, and, as a result, have discovered that a liquid crystal polymer having a block-type copolymer structure prepared from an oligomer block having a predetermined number average degree of polymerization has significantly improved barrier characteristics, such as, moisture transmission resistivity. Without being bound by theory, the liquid crystal polymer having the oligomer blocks has a reduced free volume due to improvements of packing density between polymeric chains as compared with a conventional liquid crystal polymer having a random-type copolymer structure, and this results in the significantly improved barrier characteristics, such as, moisture transmission resistivity. That is, in an embodiment, a battery case includes a container configured to house an electrode assembly, wherein the container includes a bottom wall and a plurality of side walls, the bottom wall and the plurality of side walls are integrated to define an internal space for housing the electrode assembly and to further define a top opening on an opposing side from the bottom wall, at least one of the bottom wall and the plurality of side walls includes a liquid crystal polymer, the liquid crystal polymer includes a plurality of blocks including an average of about 2 to about 5 structural units derived from hydroxybenzoic acid (HBA), and the container has a water vapor transmission rate (WVTR) at a wall thickness of 1 mm of less than about 0.07 g/m²/day, as measured at 38° C. and a relative humidity of 100% according to ISO 15106 and ASTM F1249.

A total amount of the structural units derived from hydroxybenzoic acid and forming the plurality of blocks in the liquid crystal polymer may be greater than or equal to about 30 mol %, based on a total mole number of the structural units of the liquid crystal polymer. When the total amount of the structural units derived from hydroxybenzoic acid and forming the plurality of blocks in the liquid crystal polymer is greater than or equal to about 30 mol %, based on a total mole number of the structural units of the liquid crystal polymer, the structural units derived from hydroxybenzoic acid may uniformly be distributed as oligomeric blocks in the liquid crystal polymer, and thus, the liquid crystal polymer may well exhibit characteristics of a block copolymer. That is, the liquid crystal polymer including the structural units derived from hydroxybenzoic acid and forming the plurality of blocks in an amount of the above range may have a decreased free volume in the liquid crystal polymer due to a blocking of the hydroxybenzoic acid units, and thus, barrier characteristics of the liquid crystal polymer may further be embodied compared with a liquid crystal polymer having a random-type copolymer structure prepared from a monomer of hydroxybenzoic acid in the same amount.

In addition, the total amount of the structural units derived from hydroxybenzoic acid and forming the plurality of blocks in the liquid crystal polymer may be less than about 70 mol %, based on a total mole number of structural units of the liquid crystal polymer. When the total amount of the structural units derived from hydroxybenzoic acid and forming the plurality of blocks in the liquid crystal polymer is within the range, the liquid crystal polymer may be processed and molded into an article, such as, for example, a battery case according to an embodiment. As described above, the liquid crystal polymers commonly have a drawback of difficult melting processes due to a high melting point of about 300° C. or greater, and the melting point tends to be increased as a blocking degree of the liquid crystal polymer increases. However, when the total amount of the structural units derived from hydroxybenzoic acid and forming the plurality of blocks is within the above range, the liquid crystal polymer may have a melting point, for example, of about 320° C. or less, at which a known molding method may be applied. On the contrary, when the total amount of the structural units derived from hydroxybenzoic acid and forming the plurality of blocks is greater than or equal to about 70 mol %, based on a total mole number of the structural units of the liquid crystal polymer, the melting point of the liquid crystal polymer may be increased to about 340° C. or greater, at which temperature a melt polymerization may be impossible.

For example, the total amount of the structural units derived from hydroxybenzoic acid and forming the plurality of blocks in the liquid crystal polymer may be greater than or equal to about 35 mol % and less than about 70 mol %, for example, greater than or equal to about 35 mol % and less than or equal to about 65 mol %, greater than or equal to about 40 mol % and less than or equal to about 65 mol %, greater than or equal to about 45 mol % and less than or equal to about 65 mol %, greater than or equal to about 45 mol % and less than or equal to about 60 mol %, greater than or equal to about 50 mol % and less than or equal to about 60 mol %, or greater than or equal to about 55 mol % and less than or equal to about 60 mol %, based on a total mole number of the structural units of the liquid crystal polymer, but is not limited thereto, and within the ranges, may be any amount or subranges. When the total amount of the structural units derived from hydroxybenzoic acid and forming the plurality of blocks in the liquid crystal polymer is within the ranges, the liquid crystal polymer may realize improved workability and barrier characteristics.

In an exemplary embodiment, the liquid crystal polymer may include a plurality of blocks including an average of about 2 to about 4 structural units derived from hydroxybenzoic acid, for example, a plurality of blocks including an average of about 2 to about 3 structural units derived from hydroxybenzoic acid. Herein, each block of the structural units derived from hydroxybenzoic acid included in the liquid crystal polymer may independently include a same or different number of the structural units derived from hydroxybenzoic acid, provided that the average number is within a range of 2 to 5. For example, when the liquid crystal polymer includes a plurality of blocks including an average of about 3 structural units derived from hydroxybenzoic acid, the liquid crystal polymer may consist of the plurality of blocks of 3 structural units derived from hydroxybenzoic acids, or may include at least one block of two (2) structural units derived from hydroxybenzoic acids, at least one block of three (3) structural units derived from hydroxybenzoic acids, and/or at least one block of four (4) structural units derived from hydroxybenzoic acids. Meanwhile, the average number of structural units derived from hydroxybenzoic acid in a plurality of blocks is determined from the number average degree of polymerization of an oligomer of hydroxybenzoic acid, from which the liquid crystal polymer is prepared, and a method of determining the number average degree of polymerization and the specific calculation equation thereof will be described in more detail later in the descriptions regarding the liquid crystal polymer.

A liquid crystal polymer having a plurality of blocks including an average of about 2 to about 5 structural units derived from hydroxybenzoic acid have a block-type copolymer structure and may have a reduced water vapor transmission rate that is less than or equal to about one half, for example, less than or equal to about one third, for example, less than or equal to about one fourth of a liquid crystal polymer having a random-type copolymer structure prepared from hydroxybenzoic acid in an equivalent content but as monomer, not as an oligomer block. For example, as shown in the following examples, an article (Comparative Example 1) molded by copolymerizing 50 g (about 50 mol %) of hydroxybenzoic acid and about 55.51 g (about 50 mol %) of isophthalic acid, biphenol, and hydroquinone combined as a random-type copolymer shows a water vapor transmission rate of 0.08 g/m²/day, whereas an article (Example 1) obtained by preparing 51 g (about 50 mol %) of hydroxybenzoic acid into an oligomer having a number average degree of polymerization of about 2.76 and polymerizing the oligomer with about 50 mol %, that is, the aforementioned same amount of isophthalic acid, biphenol, and hydroquinone combined shows a water vapor transmission rate of 0.023 g/m²/day. As such, the block-type copolymer structure of Example 1 shows a water vapor transmission rate reduced down to less than or equal to about one third of that of the random-type copolymer structure of Comparative Example 1.

On the other hand, in Example 2, a liquid crystal polymer is prepared by using oligomers of hydroxybenzoic acid having a number average degree of polymerization of about 2.64, which is similar to the degree of polymerization of Example 1, but with an increased amount of hydroxybenzoic acid oligomer of 57.68 g (about 60 mol %), compared with Example 1, and an article molded by using the liquid crystal polymer shows a water vapor transmission rate of 0.02 g/m²/day, which is further reduced compared with the article made from a liquid crystal polymer according to Example 1. On the other hand, an article of Example 3 molded from a liquid crystal polymer manufactured from an oligomer of hydroxybenzoic acid having a number average degree of polymerization of about 4, but with the same amount of hydroxybenzoic acid oligomer of 53.8 g (about 60 mol %) as in Example 2, has a water vapor transmission rate of 0.05 g/m²/day, which is further increased compared with that of Examples 1 and 2. In other words, the water vapor transmission rate of the article may be adjusted by controlling a number average degree of polymerization of the oligomer of hydroxybenzoic acid and an amount of the hydroxybenzoic acid oligomer in the liquid crystal polymer, and particularly, the number average degree of polymerization of the oligomer may have a larger influence on the water vapor transmission rate.

Accordingly, the battery case according to an embodiment includes a liquid crystal polymer including a plurality of blocks having an average of about 2 to about 5 structural units derived from hydroxybenzoic acid, which is prepared from oligomers of hydroxybenzoic acid having a number average degree of polymerization of about 2 to about 5, and the total amount of the structural units derived from hydroxybenzoic acid and forming the plurality of blocks in the liquid crystal polymer is in the above range, and thus, the battery case may have a remarkably improved moisture transmission resistivity compared with that of an article manufactured from a liquid crystal polymer having a random-type copolymer structure prepared from hydroxybenzoic acid as a monomer. Further, desired moisture transmission resistivity of the battery case may be obtained by adjusting the number average degree of polymerization and the content of hydroxybenzoic acid forming the plurality of blocks in the liquid crystal polymer.

Therefore, the container including the liquid crystal polymer according to an embodiment may have a water vapor transmission rate (WVTR) at a wall thickness of 1 mm of less than about 0.07 g/m²/day, for example, less than or equal to about 0.065 g/m²/day, less than or equal to about 0.06 g/m²/day, less than or equal to about 0.055 g/m²/day, less than or equal to about 0.05 g/m²/day, less than or equal to about 0.045 g/m²/day, less than or equal to about 0.04 g/m²/day, less than or equal to about 0.035 g/m²/day, less than or equal to about 0.03 g/m²/day, less than or equal to about 0.025 g/m²/day, less than or equal to about 0.024 g/m²/day, less than or equal to about 0.023 g/m²/day, less than or equal to about 0.022 g/m²/day, less than or equal to about 0.021 g/m²/day, less than or equal to about 0.02 g/m²/day, as measured at 38° C. and a relative humidity of 100% according to ISO 15106 and ASTM F1249, and such a water vapor transmission rate is significantly improved compared with a plastic-based article including a conventional known plastic, or a liquid crystal polymer having a random-type copolymer structure.

In an embodiment, the battery case may include a bottom wall and a plurality of side walls that form the container, and at least one of the bottom wall and the plurality of side walls may include the liquid crystal polymer, and for example, both the bottom wall and the plurality of sidewalls may include the liquid crystal polymer. In addition, at least one of the bottom wall and the plurality of side walls or both the bottom wall and the plurality of sidewalls may include an article produced from or comprising the liquid crystal polymer. The container is formed by integrating the bottom wall and the plurality of side walls, wherein “integrated” refers to a combination of the bottom wall with the plurality of side walls to form one continuous shape, or refers to connection of the bottom wall with the plurality of side walls to form a closed shape and define a top opening (e.g., an open side) on an opposing side from the bottom wall. The integrating method is not particularly limited, and for example, as described later, the liquid crystal polymer is molded in a form of a container having the bottom wall and the plurality of side walls in one step, or is molded into separate articles of the bottom wall and the plurality of side walls and then they are connected by known methods of welding or adhering to form an integrated shape.

In an embodiment, the liquid crystal polymer may further include at least one of a structural unit derived from an aromatic dicarboxylic acid, a structural unit derived from an aromatic diol, and a structural unit derived from an aromatic hydroxycarboxylic acid, in addition to the plurality of blocks including the structural units derived from hydroxybenzoic acid.

The structural unit derived from an aromatic dicarboxylic acid may include a structural unit derived from at least one of an aromatic dicarboxylic acid selected from terephthalic acid, 4,4′-biphenyldicarboxylic acid, 4,4′-terphenyldicarboxylic acid, 1,6-naphthalenedicarboxylic acid, 2,6-naphthalenedicarboxylic acid, 1,4-naphthalenedicarboxylic acid, 2,7-naphthalenedicarboxylic acid, diphenylether-4,4′-dicarboxylic acid, diphenoxyethane-4,4′-dicarboxylic acid, diphenoxybutane-4,4′-dicarboxylic acid, diphenylethane-4,4′-dicarboxylic acid, isophthalic acid, diphenylether-3,3′-dicarboxylic acid, diphenoxyethane-3,3′-dicarboxylic acid, diphenylethane-3,3′-dicarboxylic acid, chloroterephthalic acid, dichloroterephthalic acid, dichloroisophthalic acid, bromoterephthalic acid, methylterephthalic acid, dimethylterephthalic acid, ethylterephthalic acid, methoxyterephthalic acid, and ethoxyterephthalic acid, but is not limited thereto.

The structural unit derived from an aromatic diol may be a structural unit derived from at least one of an aromatic diol selected from catechol, resorcinol, hydroquinone, 4,4′-dihydroxybiphenyl, 2,2-bis(4′-β-hydroxyethoxyphenyl)propane, bis(4-hydroxyphenyl) sulfone, bis(4-β-hydroxyethoxyphenyl)sulfonic acid, 9,9′-bis(4-hydroxyphenyl)fluorene, 3,3′-dihydroxybiphenyl, 4,4′-dihydroxyterphenyl, 2,6-naphthalenediol, 4,4′-dihydroxydiphenylether, bis(4-hydroxyphenoxy)ethane, 3,3′-dihydroxydiphenylether, 1,6-naphthalenediol, 2,2-bis(4-hydroxyphenyl) propane, bis(4-hydroxyphenyl)methane, chlorohydroquinone, methylhydroquinone, tert-butylhydroquinone, phenylhydroquinone, methoxyhydroquinone, phenoxyhydroquinone, 4-chlororesorcinol, and 4-methylresorcinol, but is not limited thereto.

The structural unit derived from an aromatic hydroxycarboxylic acid may be a structural unit derived from at least one of an aromatic hydroxycarboxylic acid selected from glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2, 5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, and p-β-hydroxyethoxybenzoic acid, but is not limited thereto.

In an embodiment, the liquid crystal polymer may further include about mol % or less of a structural unit derived from an aromatic dicarboxylic acid and about 30 mol % or less of a structural unit derived from an aromatic diol, based on the total mole number of structural units of the liquid crystal polymer.

In an embodiment, the structural unit derived from an aromatic dicarboxylic acid may include a structural unit derived from at least one of terephthalic acid and isophthalic acid, and the structural unit derived from an aromatic diol may include a structural unit derived from at least one of hydroquinone and 4,4′-dihydroxybiphenyl.

In an embodiment, the liquid crystal polymer may further include about mol % or less of the structural unit derived from an ester monomer that is derived from an aromatic dicarboxylic acid and an aliphatic diol, based on the total mole number of structural units of the liquid crystal polymer. In other words, the ester monomer can be a monomeric unit of a polyester. When the liquid crystal polymer further includes a structural unit derived from the ester monomer, a melting point of the liquid crystal polymer may be lowered making processing easier, or when the liquid crystal polymer is mixed with a polyester that is not a liquid crystal polymer, compatibility may become better. For example, the structural unit derived from the ester monomer may be a structural unit derived from at least one ester monomer selected from ethylene terephthalate, ethylene naphthalate, trimethylene terephthalate, and butylene terephthalate, but is not limited thereto.

A melting point of the liquid crystal polymer according to one or more embodiments may be less than or equal to about 320° C.

As described, a conventional liquid crystal polymer that is a random-type copolymer has a high melting point, and thus, inferior melt workability. Further, the liquid crystal polymer having a block-type copolymer structure generally can have a higher melting point than the liquid crystal polymer of a random copolymer type, when the two liquid crystal polymers are prepared by using the same monomers as each other. As a result, the conventional art discloses reducing a blocking ratio in a liquid crystal polymer in order to prevent formation of a block-type copolymer. On the contrary, in an embodiment, a liquid crystal polymer including a plurality of blocks having an average of about 2 to about 5 of the structural units derived from hydroxybenzoic acid may have a melting point of less than or equal to 320° C. by adjusting the total amount of the structural units derived from hydroxybenzoic acid and forming the plurality of blocks within a range of greater than or equal to 30 mol % and less than or equal to 70 mol % based on a total mole number of the structural units of the liquid crystal polymer. In addition, the melting point of the liquid crystal polymer may be further decreased by further including a structural unit derived from a polyester monomer.

As described above, since the battery case according to an embodiment has a remarkably improved moisture transmission resistivity, which may not be accomplished by a conventional thermoplastic-based article including a known thermoplastic or random-type liquid crystal polymer, an electrode assembly including positive and negative electrodes may be directly inserted into the internal space therein to form a battery, and in some cases without being wrapped with an additional metal exterior material, such as, for example, a metal pouch, and the like. Conventionally, an electrode assembly including a positive and a negative electrode is formed, and then, wrapped with a metal pouch having a moisture transmission resistivity to form a battery cell. Then, the battery cell is packed in a metallic battery case having a battery cell container to manufacture a battery or a battery module. This method is complicated in terms of process, takes a long time, and is expensive.

As aforementioned, the battery case according to an embodiment may have a remarkably improved moisture transmission resistivity as described above, since a bottom wall and at least one of a plurality of side walls forming the container, for example, both the bottom wall and a plurality of side walls include an article comprising the liquid crystal polymer according to an embodiment. Herein, as described above, the battery case may closed and/or sealed by covering and/or sealing an open side of the container of the battery case with a lid configured to cover at least a part of the top opening, for example, covering the entire top opening. Herein, the lid may also be manufactured from an article including a liquid crystal polymer which forms the container of the battery case.

A method of producing an article is not particularly limited and may be appropriately selected. For example, the article may be obtained by molding the liquid crystal polymer to obtain a pellet, and molding the pellet to have a desired shape through an extrusion molding machine or an injection molding machine. A kind of the extrusion molding machine and the injection molding machine is not particularly limited but may be publicly known in the related art. This extrusion molding machine or injection molding machine is commercially available. In addition, the molding may include publicly-known various methods such as extrusion molding, injection molding, blow molding, press molding, and the like to obtain a desired size and shape.

As used herein, through the specification, the hydroxybenzoic acid may include isomers having o- (ortho-), m- (meta-), or p- (para-) structures. That is, the hydroxybenzoic acid may be o-hydroxybenzoic acid, m-hydroxybenzoic acid, p-hydroxybenzoic acid, or a combination thereof, and in an embodiment, the hydroxybenzoic acid may be p-hydroxybenzoic acid, but is not limited thereto.

Hereinafter, a battery case according to an embodiment is described with reference to the appended drawings.

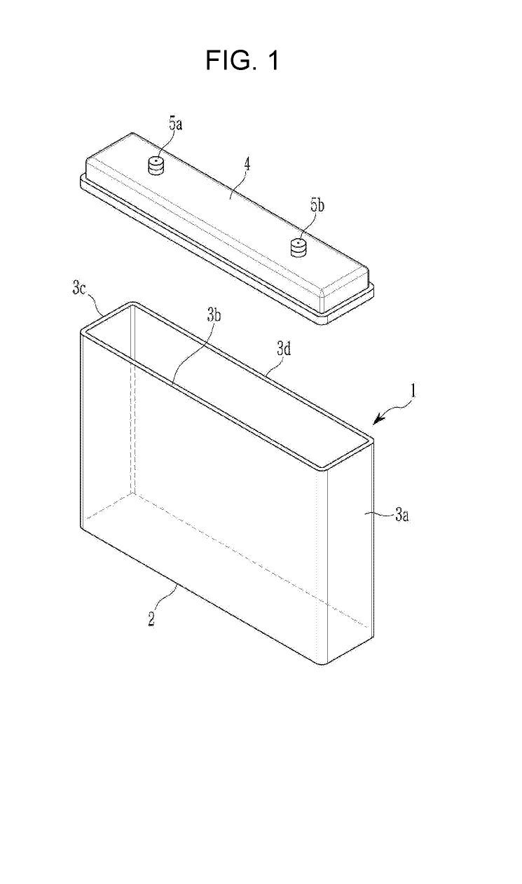

FIG. 1 is an exploded perspective view of a battery case according to an embodiment.

Referring to FIG. 1, a battery case according to an embodiment includes a container 1 including a bottom wall 2 and a plurality of (e.g., 3, 4, or greater) side walls 3a, 3b, 3c, and 3d that are integrated to provide an internal space for housing an electrode assembly. The container 1 has a top opening or an open side opposed to the bottom wall 2 and an electrode assembly may be housed in the container 1 through the top opening or open side. The battery case may further include a lid 4 to close or cover (e.g., seal) at least a part, for example, a whole part of the top opening or open side of the container 1. The lid 4 may have at least one of the positive terminal 5a and the negative terminal 5b (e.g., positive terminal and negative terminal). The lid 4 may include the same material as the container 1 or a different material from the container 1.

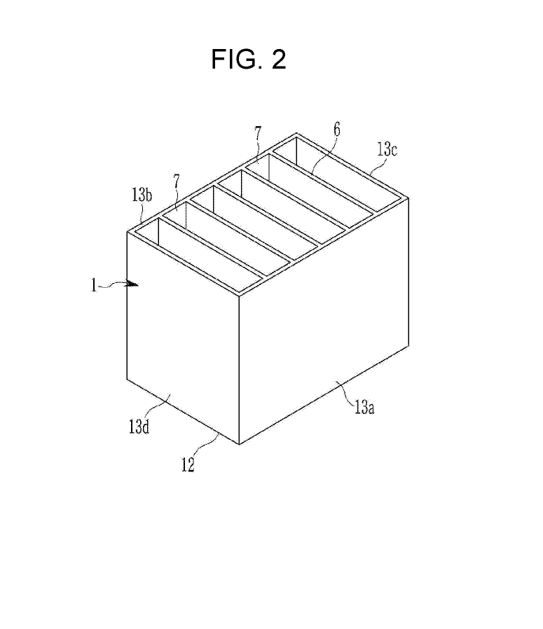

FIG. 2 is an exploded perspective view of a battery case according to another embodiment.

Referring to FIG. 2, a container 1 of a battery case according to an embodiment and includes a plurality of side walls 13a, 13b, 13c, and 13d, and a bottom wall 12 that are integrated to provide an internal space and one or more, for example, 2, 3, 4, 5, or more partition walls are provided 6 in the internal space. The internal space in the container 1 may include a plurality of, for example, 2 or more, for example, 3 or more, for example, 4 or more, or for example, 5 or more of cell compartments 7 defined by the partition walls. An electrode assembly including a positive electrode and a negative electrode may be housed in each cell compartment 7 that will be described later. The battery case may further include one or more lids to close or cover at least a portion of each cell compartment. For example, each cell compartment 7 may have a separate lid having at least one positive terminal and at least one negative terminal, or the container may include a lid that covers two or more, or all, of the cell compartments 7 such that each cell compartment 7 has at least one positive terminal and at least one negative terminal. The lid can be the same as described in FIG. 1.

FIGS. 1 and 2 show embodiments of a rectangular parallelepiped battery case, but the battery case according to an embodiment has no limit to the shape but may have various shapes and sizes and the various number of containers or cell compartments.

A battery or a battery module according to an embodiment may be manufactured by housing an electrode assembly including positive and negative electrodes in the internal space of container 1 of the battery case in FIG. 1 or respectively in the internal spaces of a plurality of cell compartments 7 in the container 1 in FIG. 2. This battery or battery module is manufactured by housing the electrode assembly in the container 1 or respectively in the cell compartments 7 of the battery case in FIG. 1 or 2 and then, injecting an electrolyte solution into the container 1 or the cell compartments 7 to supply the electrode assembly with the electrolyte solution. After injecting the electrolyte solution into the container 1 or the cell compartment 7 in which the electrode assembly is disposed, a top opening or open side of each battery case is closed or sealed with the lid 4 to manufacture the battery or battery module according to an embodiment.

Hereinafter, the electrode assembly is described.

The electrode assembly includes a positive electrode, a negative electrode, and a separator disposed therebetween. The electrode assembly may further include, for example an aqueous non-aqueous electrolyte solution in the separator. The kinds of the electrode assembly are not particularly limited. In an embodiment, the electrode assembly may include an electrode assembly for a rechargeable lithium battery. The positive electrode, the negative electrode, the separator, and the electrolyte solution of the electrode assembly may be desirably selected according to kinds of the electrode and are not particularly limited. Hereinafter, the electrode assembly for a rechargeable lithium battery is exemplified but the present disclosure is not limited thereto.

The positive electrode may include, for example, a positive active material disposed on a positive current collector and may further include at least one of a conductive material and a binder. The positive electrode may further include a filler. The negative electrode may include, for example a negative active material disposed on a negative current collector and may further include at least one of a conductive material and a binder. The negative electrode may further include a filler.

The positive active material may include, for example a (solid solution) oxide including lithium but is not particularly limited, as long as it is a material capable of intercalating and deintercalating lithium ions electrochemically. The positive active material may be a layered compound such as lithium cobalt oxide (LiCoO₂), lithium nickel oxide (LiNiO₂), and the like, a compound substituted with one or more transition metal; a lithium manganese oxide such as chemical formula Li₁₊ₓMn₂₋ₓO₄ (wherein, x is 0 to 0.33), LiMnO₃, LiMn₂O₃, LiMnO₂, and the like; lithium copper oxide (Li₂CuO₂); vanadium oxide such as LiV₃O₈, LiFe₃O₄, V₂O₅, Cu₂V₂O₇, and the like; a Ni site-type lithium nickel oxide represented by chemical formula LiNi₁₋ₓMₓO₂ (wherein, M=Co, Mn, Al, Cu, Fe, Mg, B, or Ga and x=0.01 to 0.3); a lithium manganese composite oxide represented by chemical formula LiMn₂₋ₓMₓO₂ (wherein, M=Co, Ni, Fe, Cr, Zn, or Ta and x=0.01 to 0.1), or Li₂Mn₃MO₈ (wherein, M=Fe, Co, Ni, Cu, or Zn); LiMn₂O₄ where a part of Li is substituted with an alkaline-earth metal ion; a disulfide compound; Fe₂(MoO₄)₃, and the like, but is not limited thereto.

Examples of the conductive material may be carbon black such as Ketjen black, acetylene black, and the like, natural graphite, artificial graphite, and the like, but is not particularly limited as long as it may increase conductivity of the positive electrode.

The binder may be for example, polyvinylidene fluoride, ethylene-propylene-diene terpolymer, styrene-butadiene rubber, acrylonitrile-butadiene rubber, a fluorine rubber, polyvinyl acetate, polymethylmethacrylate, polyethylene, nitrocellulose, and the like, but is not particularly limited as long as it may bind the (positive or negative) active material and the conductive material on the current collector. Examples of the binder may be polyvinyl alcohol, carboxymethyl cellulose (CMC), starch, hydroxypropyl cellulose, recycled cellulose, tetrafluoroethylene, polyethylene, polypropylene, an ethylene-propylene-diene copolymer (EPDM), sulfonated EPDM, a styrene butylene rubber, a fluorine rubber, various copolymers thereof, polymeric highly saponified polyvinyl alcohol, and the like, in addition to the foregoing materials.

The negative active material may be for example, carbonaceous materials such as natural graphite, artificial graphite, expanded graphite, carbon fiber, non-graphitizable carbon, carbon black, carbon nanotube, fullerene, activated carbon, and the like; a metal or metalloid such as Al, Si, Sn, Ag, Bi, Mg, Zn, In, Ge, Pb, Pd, Pt, Ti, and the like that may be an alloy with lithium and a compound including such an element; a composite material of a metal or metalloid and a compound thereof and carbonaceous materials; a lithium-containing nitride, and the like. Among them, carbonaceous active materials, silicon-based active materials, tin-based active materials, or silicon-carbon-based active materials may be desirably used and may be used alone or in a combination of two or more.

The separator is not particularly limited and may be any separator of a rechargeable lithium battery. For example, a porous film or non-woven fabric having excellent high rate discharge performance may be used alone or in a mixture thereof. The separator may include pores and the pores may have generally a pore diameter of about 0.01 micrometers (μm) to about 10 μm and a thickness of about 5 μm to about 300 μm. A substrate of the separator may include, for example, a polyolefin-based resin, a polyester-based resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like. When the electrolyte is a solid electrolyte such as a polymer, the solid electrolyte may function as a separator.

The conductive material is a component to further improve conductivity of an active material and may be included in an amount of about 1 wt % to about 30 wt % based on a total weight of the electrode, but is not limited thereto. Such a conductive material is not particularly limited as long as it does not cause chemical changes of a battery and has conductivity, and may be for example, graphite such as natural graphite or artificial graphite; carbon black such as acetylene black, Ketjen black, channel black, furnace black, lamp black, summer black, and the like; a carbon derivative such as carbon nanotube, fullerene, and the like, a conductive fiber such as a carbon fiber or a metal fiber, and the like; a carbon fluoride, a metal powder such as aluminum, a nickel powder, and the like; a conductive whisker such as zinc oxide, potassium titanate, and the like; a conductive metal oxide such as a titanium oxide; a conductive organic material such as a polyphenylene derivative, and the like.

The filler is an auxiliary component to suppress expansion of an electrode, is not particularly limited as long as it does not cause chemical changes of a battery and is a fiber-shaped material, and may be for example, an olefin-based polymer such as polyethylene, polypropylene, and the like; a fiber-shaped material such as a glass fiber, a carbon fiber, and the like.

In the electrode, the current collector may be a site where electron transports in an electrochemical reaction of the active material and may be a negative current collector and a positive current collector according to kinds of the electrode. The negative current collector may have a thickness of about 3 μm to about 500 μm. The negative current collector is not particularly limited as long as it does not cause chemical changes of a battery and has conductivity and may be, for example, copper, stainless steel, aluminum, nickel, titanium, fired carbon, copper or stainless steel that is surface-treated with carbon, nickel, titanium, silver, or the like, an aluminum-cadmium alloy, and the like.

The positive current collector may have a thickness of about 3 μm to about 500 μm, but is not limited thereto. Such a positive current collector is not particularly limited as long as it does not cause chemical changes of a battery and has high conductivity and may be, for example, stainless steel, aluminum, nickel, titanium, fired carbon, or aluminum or stainless steel that is surface-treated with carbon, nickel, titanium, silver, or the like.

The current collectors may have a fine concavo-convex shape on its surface to reinforce a binding force of the active material and may be used in various shapes of a film, a sheet, a foil, a net, a porous film, a foam, a non-woven fabric, or the like.

The lithium-containing non-aqueous electrolyte solution may consist of a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxyethane, tetrahydroxy franc, 2-methyltetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxymethane, a dioxolane derivative, sulfolane, methylsulfolane, 1,3-dimethyl-2-imidazolidinone, a propylene carbonate derivative, a tetrahydrofuran derivative, an ether derivative, methyl propionate, ethyl propionate, and the like.

The lithium salt is a material that is dissolved in the non-aqueous electrolyte solution and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, a lithium chloroborane, a lower aliphatic lithium carbonate, a lithium 4-phenyl borate, a lithium imide, and the like.

An organic solid electrolyte, an inorganic solid electrolyte, and the like may be used as needed.

The organic solid electrolyte may be, for example, polyethylene derivative, a polyethylene oxide derivative, a polypropylene oxide derivative, a phosphoric acid ester polymer, a poly agitation lysine, polyester sulfide, polyvinyl alcohol, polyvinylidene fluoride, a polymer including an ionic leaving group, and the like.

The inorganic solid electrolyte may be, for example, nitrides of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, and the like, halides, sulfates, and the like.

The non-aqueous electrolyte solution may include, for example, pyridine, triethyl phosphite, triethanolamine, cyclic ether, ethylene diamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride in order to improve charge and discharge characteristics, flame retardancy, and the like. As needed, in order to endow inflammability, a halogen-containing solvent such as carbon tetrachloride, ethylene trifluoride, and the like may be further added and in order to improve high temperature storage characteristics, carbon dioxide gas may be further added.

As described above, a battery module including a battery case according to an embodiment does not need manufacture of a unit cell including metal exterior materials consisting of additional moisture transmission resistivity materials on each electrode assembly, and thus an electrode assembly housed in the container of the battery case or in each cell compartment of the container does not need additional metal exterior materials.

In another embodiment, a liquid crystal polymer includes a plurality of blocks having an average of about 2 to about 5 structural units derived from hydroxybenzoic acid (HBA), wherein a total amount of the structural units derived from HBA and forming the plurality of blocks in the liquid crystal polymer is greater than or equal to about 30 mol % and less than about 70 mol %, based on a total mole number of the structural units of the liquid crystal polymer.

As described above, the liquid crystal polymer according to an embodiment is not polymerized from hydroxybenzoic acid as a monomer itself, as conventionally used, but from an oligomer derived from HBA having a predetermined number average degree of polymerization in a particular range, and thus formed as a block-type copolymer structure including a plurality of blocks of the structural units derived from HBA. Accordingly, the liquid crystal polymer according to an embodiment shows different characteristics in terms of various properties from those of a conventional liquid crystal polymer having a random-type copolymer derived by copolymerizing hydroxybenzoic acid monomers.

For example, without being bound by theory, the liquid crystal polymer having the block-type copolymer structure may have a certain regular arrangement of polymeric chains, and thus may have an increased packing density between polymeric chains by including a plurality of oligomer blocks of the structural units derived from HBA having a predetermined number average degree of polymerization. Such an increased packing density may reduce a free volume between polymeric chains, and thus, barrier characteristics against moisture or gas may be increased. For example, an article formed from this liquid crystal polymer may have water vapor transmission rate is reduced to less than or equal to about one half, less than or equal to about one third, or less than or equal to about one quarter compared with an article formed of the liquid crystal polymer obtained as a random-type copolymer by polymerizing hydroxybenzoic acid as a monomer, not as an oligomer.

In addition, the liquid crystal polymer may have a melting point of about 320° C. or less, and thus melt workability may be maintained by including the structural units derived from hydroxybenzoic acid and forming the plurality of blocks in an amount of greater than or equal to about 30 mol % and less than about 70 mol %, based on a total mole number of the structural units of the liquid crystal polymer. When the total amount of the structural units derived from hydroxybenzoic acid and forming the plurality of blocks is greater than or equal to about 70 mol %, a blocking ratio of the hydroxybenzoic acid in the liquid crystal polymer may be increased even though other monomers may be randomly copolymerized with hydroxybenzoic acid, resulting in a melting point of the liquid crystal polymer being increased to about 340° C. or greater. When the liquid crystal polymer has a high melting point, a melt process may be difficult or impossible.

In this way, the liquid crystal polymer according to an embodiment is a block-type copolymer including a plurality of blocks of predetermined average number of structural units derived from hydroxybenzoic acid, and thus, barrier characteristics, for example, water vapor transmission rate, may be further increased by controlling the number of the structural units derived from hydroxybenzoic acid and forming the plurality of blocks within a predetermined range. Further, a melting point of the liquid crystal polymer may be controlled and thus melt workability may be maintained by controlling the amount of the structural units derived from hydroxybenzoic acid and forming a plurality of blocks in the liquid crystal polymer. Therefore, the liquid crystal polymer including a plurality of blocks having an average of about 2 to about 5 structural units derived from hydroxybenzoic acid according to an embodiment and the article produced using the same may be advantageously used in various fields that require barrier characteristics.

The liquid crystal polymer may further include at least one structural unit derived from an aromatic dicarboxylic acid, a structural unit derived from an aromatic diol, and a structural unit derived from an aromatic hydroxycarboxylic acid in addition to a block of the structural units derived from hydroxybenzoic acid, and may further include a structural unit derived from a polyester monomer, wherein the polyester monomer is not derived from an aliphatic diol that is a monomer of a liquid crystal polymer, as needed. Such additional structural units and monomers are the same as described above and thus specific descriptions are omitted.

On the other hand, polymerization of hydroxybenzoic acid into an oligomer having a predetermined number average degree of polymerization may be confirmed by calculating a mole ratio of acetic acid, a reaction by-product, relative to an input amount of initial monomers. Specifically, when a monomer for producing a liquid crystal polymer, such as, hydroxybenzoic acid, is polymerized into a liquid crystal polymer, as shown in Reaction Scheme 1, one end of the monomer, for example, of hydroxybenzoic acid (HBA), is capped by acetic anhydride and acetylated, and a condensation reaction of the acetylated monomer at one end is reacted to produce an HBA block oligomer wherein n is an average of about 2 to about 5.

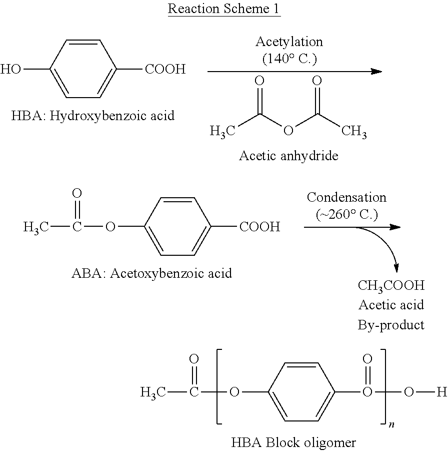

Therefore, during the acetylation reaction, the acetic anhydride acetylates one end of the HBA monomer to become acetoxybenzoic acid (ABA) and acetic acid, and the acetic acid is collected as a reaction by-product. In this way, an amount of the collected reaction by-product, acetic acid, is divided by an input amount of the initial monomer, that is, hydroxybenzoic acid, to obtain a degree of a polymerization reaction (p), and the number average degree of polymerization (DP) of HBA block oligomer is expressed by Equation 1:

DP=1/(1−p) Equation 1

wherein, p is a degree of a polymerization reaction

As a result, the number average degree of polymerization of the HBA block oligomer may be expressed by Equation 2 as follows:

DP=1/(1−mole number of acetic acid (mol_{AC})/mole number of hydroxybenzoic acid (mol_{HBA})) Equation 2

Therefore, in the liquid crystal polymer including a plurality of blocks having a predetermined number of the structural units derived from hydroxybenzoic acid according to an embodiment, the number of the structural units derived from hydroxybenzoic acid in the plurality of blocks may be controlled by controlling a collection amount of the acetic acid, which is a reaction by-product.

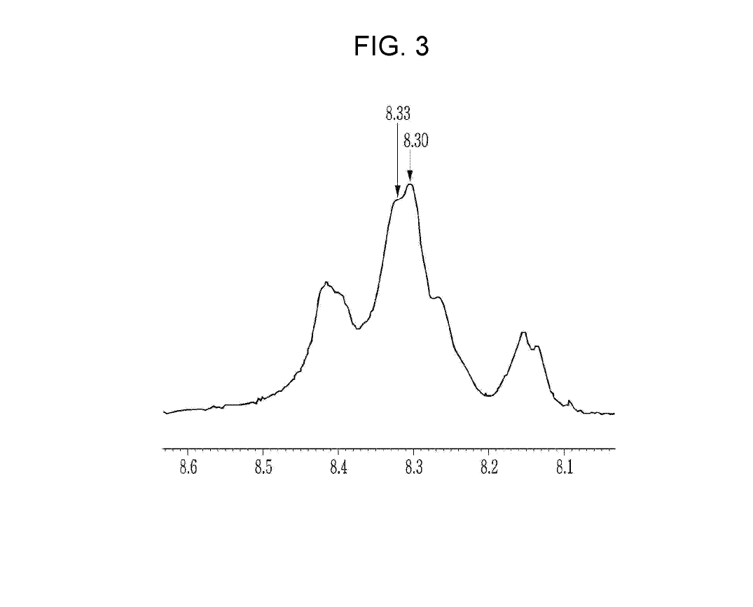

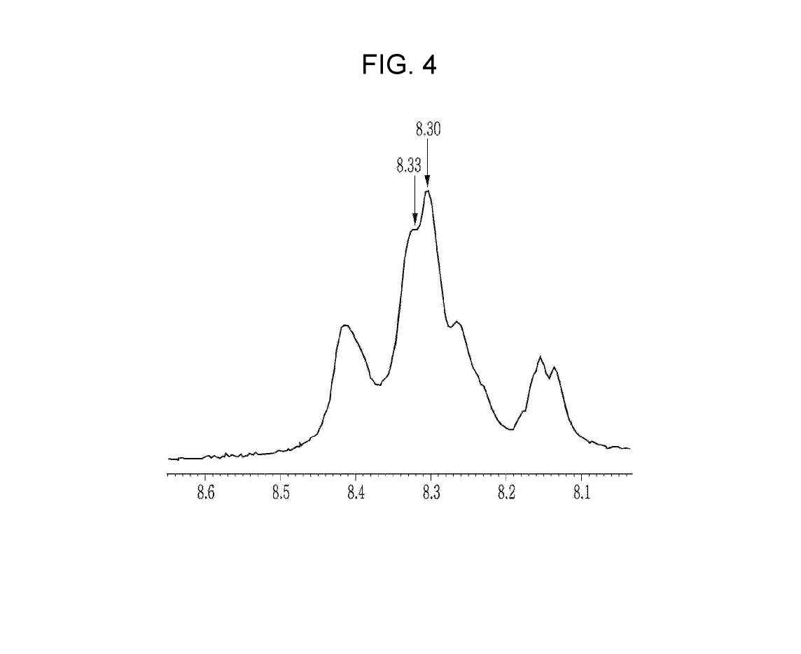

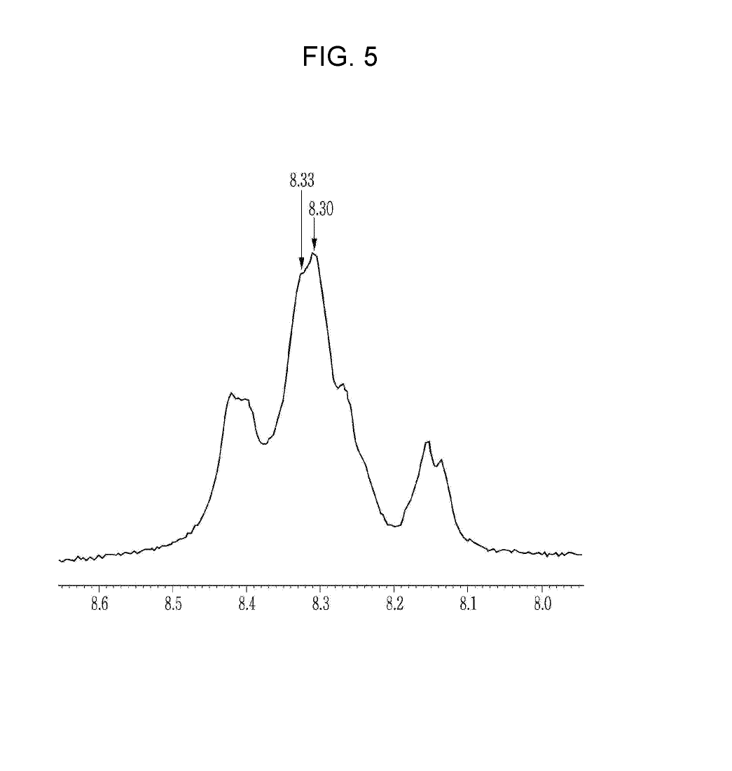

On the other hand, it may be confirmed whether the liquid crystal polymer prepared by copolymerization of hydroxybenzoic acid is a random-type copolymer or a block-type copolymer by ¹H-NMR (hydrogen nuclear magnetic resonance) analysis, and a number average degree of polymerization of the block may also be confirmed by ¹H-NMR analysis. The ¹H-NMR analysis method is a known method by a person having an ordinary skill in the art. For example, FIG. 3 shows a ¹H-NMR graph of the liquid crystal polymer according to Example 2 prepared from an oligomer of hydroxybenzoic acid having a number average degree of polymerization of about 2.64 prepared in Synthesis Example 2, FIG. 4 shows a ¹H-NMR graph of the liquid crystal polymer according to Example 3 prepared from an oligomer of hydroxybenzoic acid having a number average degree of polymerization of about 4 prepared in Synthesis Example 3, and FIG. 5 shows a ¹H-NMR graph of the liquid crystal polymer having a type of a random-type copolymer structure according to Comparative Example 2 prepared by copolymerization hydroxybenzoic acid in a state of a monomer with TPA (terephthalic acid). Each graph of FIGS. 3 to 5, a blocking ratio of the liquid crystal polymer and/or a number average degree of polymerization of the oligomer may be analyzed from sizes, positions, and shapes of each peak. For example, from FIGS. 3 and 4, the liquid crystal polymers including a block of the structural units derived from hydroxybenzoic acid and having a number average degree of polymerization of about 2 to about according to an embodiment show two or more overlapping peaks due to an aromatic hydrogen adjacent to the carboxyl group of the hydroxybenzoic acid between 8.2 ppm to 8.4 ppm in the ¹H-NMR graph. Each area by curve-fits of the highest intensity peaks between 8.30 ppm and 8.33 ppm is obtained and A_{8.3}/A_{8.33} is greater than or equal to 1 when the area at 8.30 ppm (A_{8.3}) is divided by the area at 8.33 ppm (A_{8.33}). That is, the peak at 8.30 ppm has a greater area. On the contrary, the liquid crystal polymer prepared from HBA as a monomer and having a random-type copolymer structure, not a block-type copolymer structure, shows an area ratio of A_{8.3}/A_{8.33} of less than 1, which is obtained from areas of two peaks at the positions shown in FIG. 5. In this way, even if the hydroxybenzoic acid is included in an equivalent amount, ¹H-NMR graphs may be different depending on whether the polymer is a random-type copolymer or a block-type copolymer.

An article molded in a 1 mm thickness using the liquid crystal polymer may have a water vapor transmission rate (WVTR) of less than about 0.07 g/m²/day, for example, less than or equal to about 0.065 g/m²/day, less than or equal to about 0.06 g/m²/day, less than or equal to about 0.055 g/m²/day, less than or equal to about 0.05 g/m²/day, less than or equal to about 0.045 g/m²/day, less than or equal to about 0.04 g/m²/day, less than or equal to about 0.035 g/m²/day, less than or equal to about 0.03 g/m²/day, less than or equal to about 0.025 g/m²/day, less than or equal to about 0.024 g/m²/day, less than or equal to about 0.023 g/m²/day, less than or equal to about 0.022 g/m²/day, less than or equal to about 0.021 g/m²/day, or less than or equal to about 0.02 g/m²/day that is measured at 38° C. and a relative humidity of 100% according to ISO 15106 and ASTM F1249, and such a water vapor transmission rate has significantly improved and could not be realized using known liquid crystal polymers, including those of the prior art.

Other explanations of the liquid crystal polymer are the same as described above, and thus their specific descriptions are omitted.

Hereinafter, the embodiments are described with reference to examples and comparative examples. The following examples and comparative examples are exemplary but do not limit the scope of the present disclosure.

### EXAMPLES

### Synthesis Examples 1 to 3: Synthesis of Oligomer of Hydroxybenzoic Acid

### Synthesis Example 1

100 g of hydroxybenzoic acid (HBA) and 88.7 g of acetic anhydride are put into 200 ml glass reactor equipped with a torque meter, a thermometer, and a reflux condenser to assemble a reactor, and then at 150 revolutions per minute (rpm), a reaction temperature is increased to 140° C. for 30 minutes and is maintained at 140° C. for 1 hour. Then the reflux condenser is replaced by a dean-stark condenser and a reaction by-product is collected while increasing a temperature slowly. After increasing the temperature for 1 hour, a reaction is completed at a reaction temperature of 240° C. and reaction products are collected. A weight of the collected reaction by-product is 86 g.

### Synthesis Example 2

120 g of hydroxybenzoic acid (HBA) and 107.9 g of acetic anhydride are put into 200 ml of a glass reactor equipped with a torque meter, a thermometer, and a reflux condenser to assemble a reactor, and then at 150 rpm, a reaction temperature is increased to 140° C. for 30 minutes and is maintained at 140° C. for 1 hour. Then the reflux condenser is replaced by a dean-stark condenser and a reaction by-product is collected while increasing a temperature slowly. After increasing the temperature for 1 hour, a reaction is completed at a reaction temperature of 240° C. and reaction products are collected. A weight of the collected reaction by-product is 103.75 g.

### Synthesis Example 3

Synthesis is performed according to the same method as in Synthesis Example 2 except that the reaction is terminated at a reaction temperature of 260° C. to collect the reaction products. A weight of the collected reaction by-product is 110.5 g.

HBA average degrees of polymerization of the reaction products prepared according to Synthesis Examples 1 to 3 are shown in Table 1.

TABLE 1

| | | | | HBA |
|---|---|---|---|---|
| | | | | number |
| | | Acetic | Acetic | average |
| | HBA | anhydride | acid/HBA | degree of |
| | (g) | (g) | mole ratio | polymerization |
| Synthesis Example 1 | 100 | 88.7 | 0.638 | 2.76 |
| Synthesis Example 2 | 120 | 107.9 | 0.621 | 2.64 |
| Synthesis Example 3 | 120 | 107.9 | 0.75 | 4 |

As shown in Table 1, as an amount ratio (a mole ratio) of acetic acid produced as a reaction by-product relative to initially-input hydroxybenzoic acid, that is, the reaction degree p increases, the number average degree of polymerization DP of hydroxybenzoic acid sharply increases.

In addition, while Synthesis Examples 2 and 3 used same amounts of hydroxybenzoic acid and acetic anhydride put in as reactants, Synthesis Example 3 showed a higher reaction degree p, that is, the amount ratio (mole ratio) of acetic acid produced as a reaction by-product relative to initially-input hydroxybenzoic acid, than that of Synthesis Example 2, and accordingly, an oligomer of hydroxybenzoic acid obtained from Synthesis Example 3 showed a much higher number average degree of polymerization.

### Examples 1 to 3 and Comparative Examples 1 and 2: Production of Liquid Crystal Polymer

### Example 1

30.07 g of IPA (isophthalic acid), 13.48 g of BP (biphenol), 11.96 g of HQ (hydroquinone), and 44.35 g of acetic anhydride are put into a 200 ml glass reactor equipped with a torque meter, a thermometer, and a reflux condenser to assemble a reactor, and then at 150 rpm, a reaction temperature is increased to 140° C. for 30 minutes and is maintained at 140° C. for 1 hour. Then the reflux condenser is replaced by a dean-stark condenser and a temperature is slowly increased to 330° C., over 2 hours. Herein, during increasing the temperature, 51 g of the HBA oligomer prepared in Synthesis Example 1 is added at 230° C., and 50 mg of TiOBu₄ is added at 280° C. When the temperature of the reaction reaches 330° C., a pressure is slowly reduced to 10 torr, over 30 minutes, and at 10 torr and an agitation torque of 0.4 A, the reaction is terminated to collect a polymerization product. An amount of the structural units derived from HBA is 50 mol % based on a total mole number of the structural units of the prepared polymerization product.

### Example 2

57.68 g of the HBA oligomer prepared in Synthesis Example 2, 16.54 g of TPA (terephthalic acid), 12.36 g of BP, 3.65 g of HQ, 12.74 g of PET (polyethylene terephthalate), and 70 g of acetic anhydride are put into a 200 ml glass reactor equipped with a torque meter, a thermometer, and a reflux condenser to assemble a reactor, and then at 150 rpm, a reaction temperature is increased to 140° C. for 30 minutes and is maintained at 140° C. for 1 hour. Then the reflux condenser is replaced by a dean-stark condenser and a temperature is slowly increased to 330° C., over 2 hours. When the temperature of the reactant reaches 330° C., a pressure is slowly reduced to 10 torr over 30 minutes, and at 10 Torr and an agitation torque of 0.4 A, the reaction is terminated to collect a polymerization product. An amount of the HBA-derived structural units is 60 mol % based on a total mole number of the structural units of the prepared polymerization product.

### Example 3

53.8 g of the HBA oligomer prepared in Synthesis Example 3, 16.54 g of TPA, 12.36 g of BP, 3.65 g of HQ, 12.74 g of PET, and 70 g of acetic anhydride are put into a 200 ml glass reactor equipped with a torque meter, a thermometer, and a reflux condenser to assemble a reactor, and then at 150 rpm, a reaction temperature is increased to 140° C. for 30 minutes and is maintained at 140° C. for 1 hour. Then, the reflux condenser is replaced by a dean-stark condenser and a temperature is slowly increased to 330° C., over 2 hours. When the temperature of the reactant reaches 330° C., a pressure is slowly reduced to 10 Torr over 30 minutes, and at 10 Torr and an agitation torque of 0.4 A, the reaction is terminated to collect a polymerization product. An amount of the HBA-derived structural units is 60 mol % based on a total mole number of the structural units of the prepared polymerization product.

### Comparative Example 1

50 g of a hydroxybenzoic acid (HBA) monomer and 88.7 g of acetic anhydride are put into a 200 ml glass reactor equipped with a torque meter, a thermometer, and a reflux condenser to assemble a reactor, and then at 150 rpm, a reaction temperature is increased to 140° C. for 30 minutes and is maintained at 140° C. for 1 hour. Then the reflux condenser is replaced by a dean-stark condenser and a temperature is slowly increased to 330° C., over 2 hours. When the temperature of the reactant reaches 330° C., a pressure is slowly reduced to 10 Torr over 30 minutes, and at 10 Torr and an agitation torque of 0.4 A, the reaction is terminated to collect a polymerization product. An amount of the HBA-derived structural units is 50 mol % based on a total mole number of the structural unit of the prepared polymerization product.

### Comparative Example 2

55 g of a HBA monomer, 16.54 g of TPA (terephthalic acid), 12.36 g of BP, 3.65 g of HQ, 12.74 g of PET (polyethylene terephthalate), and 79.83 g of acetic anhydride are put into a 200 ml glass reactor equipped with a torque meter, a thermometer, and a reflux condenser to assemble a reactor, and then at 150 rpm, a reaction temperature is increased to 140° C. for 30 minutes and is maintained at 140° C. for 1 hour. Then the reflux condenser is replaced by a dean-stark condenser and a temperature is slowly increased to 330° C., over 2 hours. When the temperature of the reactant reaches 330° C., a pressure is slowly reduced to 10 Torr over 30 minutes, and at 10 Torr and an agitation torque of 0.4 A, the reaction is terminated to collect a polymerization product. An amount of the HBA-derived structural units is 60 mol % based on a total mole number of the structural units of the prepared polymerization product.

### Evaluation

Each composition of the liquid crystal polymers according to Examples 1 to 3 and Comparative Examples 1 and 2, and water vapor transmission rate of each article injection-molded from the liquid crystal polymers are shown in Table 2.

Specifically, the liquid crystal polymers according to the Examples and Comparative Examples are respectively cut into an about 1 cm-long size with a cutter, mixed while injected into an extruder including two screws heated at 280° C. and spinning at the same direction, and injection-molded at 310° C. to manufacture a disk-shaped article having a diameter of 30 mm and a thickness of about 1 mm. A water vapor transmission rate of each manufactured article is measured at 38° C. under relative humidity of 100% with an Aquatran equipment (Mocon Inc.) according to ISO 15106-3, and the results are shown in Table 2.

TABLE 2

| | HBA | HBA | | | | | | |
|---|---|---|---|---|---|---|---|---|
| | Monomer | Oligomer | TPA | IPA | BP | HQ | PET | WVTR |
| | (g) | (g) | (g) | (g) | (g) | (g) | (g) | (g/m²/day) |
| Example 1 | — | 51 | — | 30.07 | 13.48 | 11.96 | — | 0.023 |
| | | (Synthesis | | | | | | |
| | | Example 1) | | | | | | |
| Example 2 | — | 57.68 | 16.54 | — | 12.36 | 3.65 | 12.74 | 0.02 |
| | | (Synthesis | | | | | | |
| | | Example 2) | | | | | | |
| Example 3 | — | 53.8 | 16.54 | — | 12.36 | 3.65 | 12.74 | 0.05 |
| | | (Synthesis | | | | | | |
| | | Example 3) | | | | | | |
| Comparative | 50 | — | — | 30.07 | 13.48 | 11.96 | — | 0.08 |
| Example 1 | | | | | | | | |
| Comparative | 55 | — | 16.54 | — | 12.36 | 3.65 | 12.74 | 0.08 |
| Example 2 | | | | | | | | |

As shown in Table 2, after manufacturing HBA into an oligomer having a number average degree of polymerization of about 2 to about 5 according to Examples 1 to 3, the oligomer was reacted with other monomers to manufacture a liquid crystal polymer, and an article was obtained therefrom. The water vapor transmission rates of the articles obtained from the liquid crystal polymers according to Examples 1 to 3, where the liquid crystal polymers were prepared by reacting an oligomer of HBA having a number average degree of polymerization of about 2 to about 5 with other monomers, reduced down to about 25% of those of the articles formed from the liquid crystal polymers including the same amount, that is, 50 mol % or 60 mol % of HBA, but copolymerized as a monomer state, not as an oligomer state, according to Comparative Examples 1 and 2. This is a remarkably improved water vapor transmission rate that cannot be accomplished by an article formed from a conventional liquid crystal polymers, including those available in the art, and thus shows excellent barrier characteristics of the liquid crystal polymer according to an embodiment.

On the other hand, the article prepared from the liquid crystal polymer according to Example 2 having a similar number average degree of polymerization of about 2.64 of hydroxybenzoic acid to that of Example 1 but including 60 mol % of hydroxybenzoic acid, which is larger than 50 mol % of Example 1, shows a reduced water vapor transmission rate of 0.02 g/m²/day, which is further lower than 0.023 g/m²/day of Example 1. On the contrary, an article of the liquid crystal polymer of Example 3 using 60 mol % of hydroxybenzoic acid like Example 2 but manufactured from an oligomer from hydroxybenzoic acid having a higher number average degree of polymerization (about 4) shows a little increased water vapor transmission rate of 0.05 g/m²/day compared with that of Example 1 or 2. Accordingly, a number average degree of polymerization of an oligomer block and an amount of the structural units derived from hydroxybenzoic acid in a liquid crystal polymer may be adjusted to control a water vapor transmission rate of an article formed therefrom.

Accordingly, an article manufactured by molding a block-type copolymer of the liquid crystal polymer formed from the oligomer block derived from hydroxybenzoic acid having an average degree of polymerization of about 2 to about 5 according to an embodiment, particularly, a liquid crystal polymer including greater than or equal to 30 mol % and less than 70 mol % of the structural units derived from hydroxybenzoic acid forming the oligomer, based on a total mole number of the structural units derived from the monomers forming the liquid crystal polymer, shows a remarkably reduced water vapor transmission rate compared with an article manufactured from a liquid crystal polymer without the oligomer comprising HBA structural units, and thus may be advantageously used for various products requiring reduced water vapor transmission rate, for example, an electronic device susceptible to moisture or a packing container of a rechargeable lithium battery and the like. In addition, the article may be manufactured into a packing container having various shapes and a desired size by molding a polymer material having a melting point of less than or equal to 320° C. in a conventional molding method.

On the other hand, FIGS. 3 to 5 show ¹H-NMR graphs of the block-type copolymer of the liquid crystal polymers according to Examples 2 and 3 and the random-type copolymer of the liquid crystal polymer according to Comparative Example 2, and Table 3 shows a curve-fit area and an area ratio (A8.3/A8.33) of the two highest intensity peaks (at 6=8.3 ppm and 6=8.33 ppm) between 8.2 ppm to 8.4 ppm in each graph. The two peaks are indicative of the two aromatic hydrogen atoms neighboring a carboxyl group of each hydroxybenzoic acid structural unit.

TABLE 3

| | Peak area | | Peak area ratio |
|---|---|---|---|
| | δ = 8.30 ppm | δ = 8.33 ppm | (A_{8.30}/A_{8.33}) |
| Example 2 | 3970.371 | 3666.86 | 1.082771363 |
| Example 3 | 3325.74 | 2505.608 | 1.327318559 |
| Comparative | 2901.759 | 3932.529 | 0.73788623 |
| Example 2 | | | |

As shown in Table 3 and FIGS. 3 to 5, since the peak at 6=8.30 ppm has a larger area than that of the peak at 6=8.33 ppm out of the peaks caused by the two hydrogen atoms in the liquid crystal polymer including HBA structural units as an oligomer block in the liquid crystal polymers according to Examples 2 and 3, the peaks show an area ratio of greater than or equal to 1, but since a peak at 6=8.30 ppm has a smaller area than that of a peak at 6=8.33 ppm out of the peaks by the two hydrogen atoms in the liquid crystal polymer including HBA structural units as a random-type copolymer according to Comparative Example 2, the peak area ratio is less than 1. This difference may be used to examine a number average degree of polymerization and/or a blocking degree of HBA in a liquid crystal polymer.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A battery case comprising a container configured to house an electrode assembly,
wherein the container comprises a bottom wall and a plurality of side walls,
the bottom wall and the plurality of side walls are integrated to define an internal space therein for housing the electrode assembly and to further define a top opening on an opposing side from the bottom wall,
at least one of the bottom wall and the plurality of side walls comprises a liquid crystal polymer,
the liquid crystal polymer comprises a plurality of blocks comprising an average of about 2 to about 5 structural units derived from hydroxybenzoic acid, and
the container has a water vapor transmission rate at a wall thickness of 1 millimeter of less than about 0.07 grams per square meter per day, as measured at 38° C. and a relative humidity of 100% according to ISO 15106 and ASTM F1249.

2. The battery case of claim 1, wherein a total amount of the structural units derived from hydroxybenzoic acid and forming the plurality of blocks in the liquid crystal polymer is greater than or equal to about 30 mole percent, based on a total mole number of structural units of the liquid crystal polymer.

3. The battery case of claim 1, wherein a total amount of the structural units derived from hydroxybenzoic acid and forming the plurality of blocks in the liquid crystal polymer is less than about 70 mole percent, based on a total mole number of structural units of the liquid crystal polymer.

4. The battery case of claim 1, wherein in the liquid crystal polymer the plurality of blocks comprise an average of about 2 to about 4 structural units derived from hydroxybenzoic acid.

5. The battery case of claim 1, wherein a total amount of the structural units derived from hydroxybenzoic acid and forming the plurality of blocks in the liquid crystal polymer is greater than or equal to about 35 mole percent and less than or equal to about 65 mole percent, based on a total mole number of structural units of the liquid crystal polymer.

6. The battery case of claim 1, wherein the liquid crystal polymer further comprises at least one of a structural unit derived from an aromatic dicarboxylic acid, a structural unit derived from an aromatic diol, and a structural unit derived from an aromatic hydroxycarboxylic acid.

7. The battery case of claim 6, wherein the structural unit derived from the aromatic dicarboxylic acid comprises a structural unit derived from at least one of terephthalic acid, 4,4′-biphenyldicarboxylic acid, 4,4′-terphenyldicarboxylic acid, 1,6-naphthalenedicarboxylic acid, 2,6-naphthalenedicarboxylic acid, 1,4-naphthalenedicarboxylic acid, 2,7-naphthalenedicarboxylic acid, diphenylether-4,4′-dicarboxylic acid, diphenoxyethane-4,4′-dicarboxylic acid, diphenoxybutane-4,4′-dicarboxylic acid, diphenylethane-4,4′-dicarboxylic acid, isophthalic acid, diphenylether-3,3′-dicarboxylic acid, diphenoxyethane-3,3′-dicarboxylic acid, diphenylethane-3,3′-dicarboxylic acid, chloroterephthalic acid, dichloroterephthalic acid, dichloroisophthalic acid, bromoterephthalic acid, methylterephthalic acid, dimethylterephthalic acid, ethylterephthalic acid, methoxyterephthalic acid, and ethoxyterephthalic acid.

8. The battery case of claim 6, wherein the structural unit derived from the aromatic diol comprises a structural unit derived from at least one of catechol, resorcinol, hydroquinone, 4,4′-dihydroxybiphenyl, 2,2-bis(4′-β-hydroxyethoxyphenyl) propane, bis(4-hydroxyphenyl) sulfone, bis(4-β-hydroxyethoxyphenyl) sulfonic acid, 9,9′-bis(4-hydroxyphenyl)fluorene, 3,3′-dihydroxybiphenyl, 4,4′-dihydroxyterphenyl, 2,6-naphthalenediol, 4,4′-dihydroxydiphenylether, bis(4-hydroxyphenoxy)ethane, 3,3′-dihydroxydiphenylether, 1,6-naphthalenediol, 2,2-bis(4-hydroxyphenyl)propane, bis(4-hydroxyphenyl)methane, chlorohydroquinone, methylhydroquinone, tert-butylhydroquinone, phenylhydroquinone, methoxyhydroquinone, phenoxyhydroquinone, 4-chlororesorcinol, and 4-methylresorcinol.

9. The battery case of claim 6, wherein the structural unit derived from the aromatic hydroxycarboxylic acid comprises a structural unit derived from at least one of glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, and p-β-hydroxyethoxybenzoic acid.

10. The battery case of claim 1, wherein the liquid crystal polymer further comprises about 30 mole percent or less of a structural unit derived from an aromatic dicarboxylic acid, and about 30 mole percent or less of a structural unit derived from an aromatic diol, based on a total mole number of structural units of the liquid crystal polymer.

11. The battery case of claim 10, wherein the structural unit derived from the aromatic dicarboxylic acid comprises a structural unit derived from at least one of terephthalic acid and isophthalic acid, and the structural unit derived from the aromatic diol comprises a structural unit derived from at least one of hydroquinone and 4,4′-dihydroxybiphenyl.

12. The battery case of claim 6, wherein the liquid crystal polymer further comprises about 30 mole percent or less of a structural unit derived from a an ester monomer that is derived from an aromatic dicarboxylic acid and an aliphatic diol, based on a total mole number of structural units of the liquid crystal polymer.

13. The battery case of claim 12, wherein the structural unit derived from the ester monomer comprises at least one of ethylene terephthalate, ethylene naphthalate, trimethylene terephthalate, and butylene terephthalate.

14. The battery case of claim 1, wherein a melting point of the liquid crystal polymer is less than or equal to about 320° C.

15. The battery case of claim 1, wherein the container further comprises a lid configured to cover at least a part of the top opening of the container, and comprising at least one of a positive terminal and a negative terminal.

16. The battery case of claim 15, wherein the lid comprises the liquid to crystal polymer.

17. A battery comprising:
the battery case of claim 1, and
the electrode assembly comprises a positive electrode and a negative electrode housed in the internal space of the container of the battery case.

18. The battery of claim 17, wherein the electrode assembly does not comprise a metal exterior material.

19. The battery of claim 17, wherein the electrode assembly is configured for use as a rechargeable lithium battery.

20. A liquid crystal polymer comprising:
a plurality of blocks comprising an average of about 2 to about 5 structural units derived from hydroxybenzoic acid, wherein a total amount of the structural units derived from hydroxybenzoic acid and forming the plurality of blocks in the liquid crystal polymer is greater than or equal to about 30 mole percent and less than about 70 mole percent, based on a total mole number of structural units of the liquid crystal polymer.

21. An article comprising the liquid crystal polymer of claim 20.

22. A method for manufacturing the liquid crystal polymer of claim 20, comprising:
providing an oligomer comprising an average of about 2 to about 5 structural units derived from hydroxybenzoic acid; and
polymerizing the oligomer and one or more monomers to obtain the liquid crystal polymer.

23. The method of claim 22, wherein the one or more monomers comprise an aromatic dicarboxylic acid, an aromatic diol, an aromatic hydroxycarboxylic acid, or a combination thereof.
